(19) United States
(12) Patent Application Publication
(10) Pub. No.: US 2021/0196574 A1
(43) Pub. Date: Jul. 1, 2021

(54) PILL DISPENSER

(71) Applicant: GSW Creative Corp., Santa Monica, CA (US)

(72) Inventor: Thomas FORNARELLI, Chicago, IL (US)

(73) Assignee: GSW Creative Corp., Santa Monica, CA (US)

(21) Appl. No.: 17/201,417

(22) Filed: Mar. 15, 2021

Related U.S. Application Data
(63) Continuation of application No. PCT/US2018/054435, filed on Oct. 4, 2018.

(51) Int. Cl. A61J 7/00; A61J 7/02; B65D 83/04

(52) U.S. Cl. CPC A61J 7/0076; B65D 83/0409; A61J 7/02

(57) ABSTRACT

A pill dispenser comprises a housing having first and second opposing interior generally flat surfaces and an exterior circumferential edge. A circular carousel is disposed to rotate within the housing. The carousel extends beyond the edge and outwardly facing recesses disposed on the carousel line up with an opening disposed through the edge.

### CROSS-REFERENCE TO RELATED APPLICATIONS

This application is a bypass Continuation of International Application No. PCT/US2018/054435, filed Oct. 4, 2018 and titled “PILL DISPENSER,” the entire contents of which are expressly incorporated by reference herein for all purposes.

### FIELD OF THE INVENTION

The present invention relates to a portable single dose dispenser for pills or tablets. More specifically, the present invention relates to a portable manually operated dispenser single use single dose dispenser for pills or tablets having a safety mechanism for preventing unwanted access to the pills or tablets.

### BACKGROUND

Pills, tablets, caplets. and other terminology used for describing the same are referred to generally herein as pills; however, no limitation on the shape, structure, or contents of said pills is intended by the general use of the word pills. Persons on medication for various reasons or purposes often require a dose of the medication delivered periodically while traveling or in situations where a conventional pill bottle may not be adequate. A handheld pill dispenser is well suited for these situations, but there are problems with existing handheld pill dispensers.

A handheld pill dispenser that manually dispenses a single pill at a time only while a simple safety mechanism is activated is not known in the art. Another feature not found on handheld pill dispensers is a reliable system for indicating the fill level of the dispenser to a user while not exposing any of the undispensed pills to the environment. There is therefore a need for a handheld pill dispenser having these dispensing and safety features.

### SUMMARY OF THE INVENTION

According to one aspect of the invention, a pill dispenser comprises a housing having first and second opposing interior generally flat surfaces and an exterior circumferential edge. A circular carousel is disposed to rotate within the housing. The carousel extends beyond the edge, and outwardly facing recesses disposed on the carousel line up with an opening disposed through the edge.

According to another aspect of the invention, a pill dispenser comprises a housing having first and second opposing interior generally flat surfaces and an exterior circumferential edge. A circular carousel is disposed to rotate within the housing. The carousel extends beyond the edge, and outwardly facing recesses disposed on the carousel line up with an opening disposed through the edge. At least one button is accessible through an exterior surface of the housing and configured to prevent rotation of the carousel unless the at least one button is depressed.

According to a further aspect of the invention, a pill dispenser comprises a housing having first and second opposing interior generally flat surfaces defining a space therebetween for accommodating pills, and an exterior circumferential edge. A circular carousel is disposed to rotate within the housing. The carousel extends beyond the edge, and outwardly facing recesses disposed on the carousel line up with an opening disposed through the edge. At least one button is accessible through an exterior surface of the housing and configured to prevent rotation of the carousel unless the at least one button is depressed. Rotation of the carousel when the at least one button is depressed delivers one pill per recess from the space to the opening.

### BRIEF DESCRIPTION OF THE DRAWINGS

FIG. 1 is a perspective view of an embodiment of a pill dispenser illustrating the pill dispenser in two orientations.

FIG. 2 is an exploded perspective view of the pill dispenser illustrating the internal components thereof.

FIG. 3 is a perspective view of an embodiment of an internal member for a pill dispenser.

FIG. 4 is a perspective view of an inside of the pill dispenser where a first side of the housing has been lifted off the pill dispenser.

FIG. 5 is a perspective view of an embodiment of a carousel of a pill dispenser.

FIG. 6 is a perspective view of an inside of the pill dispenser where a second side of the housing has been lifted off the pill dispenser.

Other aspects and advantages of the present invention will become apparent upon consideration of the following detailed description, wherein similar structures have similar reference numerals.

### DETAILED DESCRIPTION

The following detailed embodiments presented herein are for illustrative purposes. That is, these detailed embodiments are intended to be exemplary of the present invention for the purposes of providing and aiding a person skilled in the pertinent art to readily understand how to make and use of the present invention.

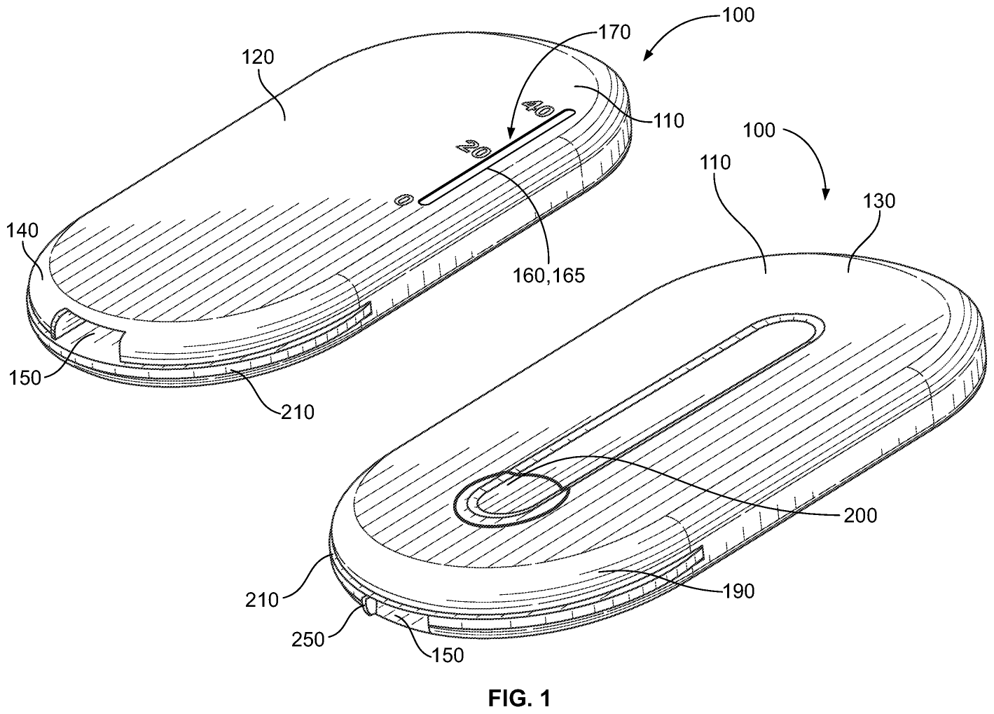

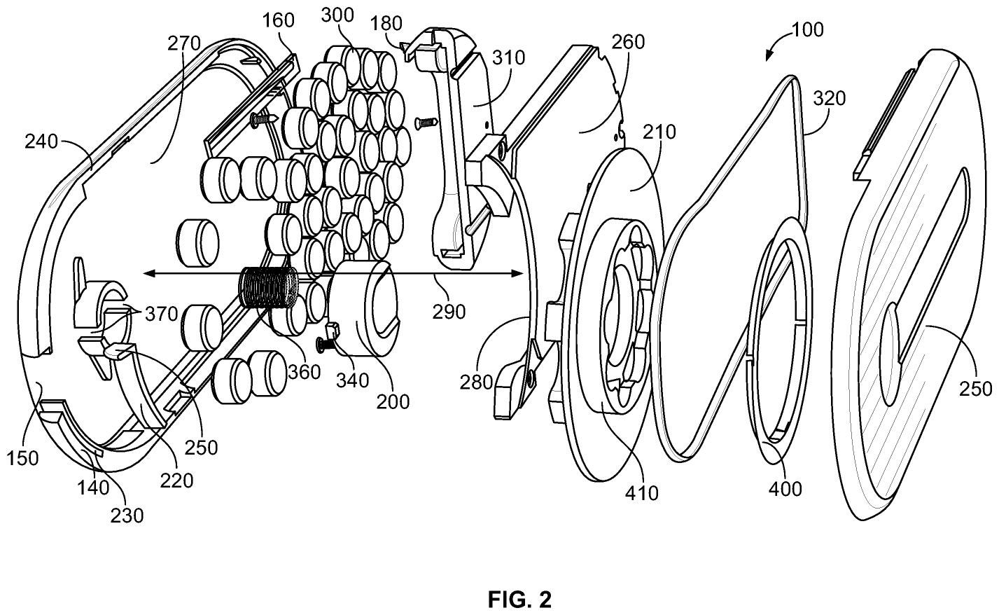

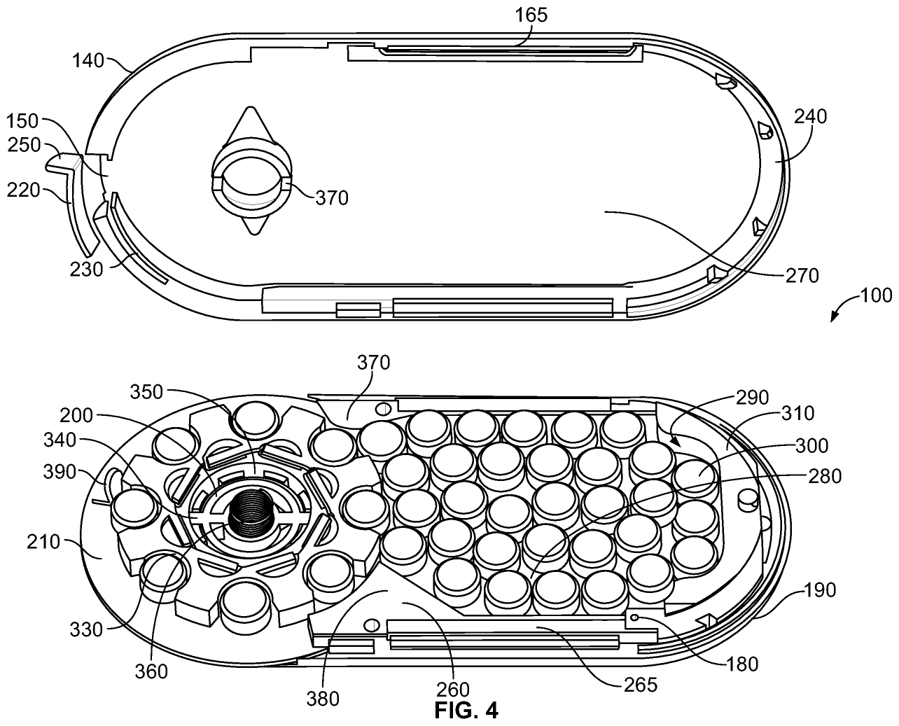

An overview of an embodiment of a pill dispenser 100 can be conveniently provided with reference to FIG. 1 that illustrates external views of the pill dispenser 100 in two orientations. The pill dispenser 100 comprises a housing 110 having different first and second outwardly facing sides, 120, 130, as illustrated. The first outwardly facing side 120, illustrated as facing up on the left in FIG. 1, includes a first circumferential edge 140 having an opening 150 disposed therethrough. The first outwardly facing side 120 also includes a window 160 disposed over a second opening 165 disposed through the housing 110 and having a scale 170 disposed along the window 160. In one embodiment, an internal mechanism, for example, a position marker 180 (see FIGS. 2 and 4) viewable through the window 160 moves in association with the fill level of the pill dispenser 100 as will be more fully described below. The scale 170 provides an indication of how many items, for example, pills there are within the housing 110 based upon the position of the marker 180 relative to the scale 170.

The second outwardly facing side 130, illustrated as facing up on the right in FIG. 1, includes a second circumferential edge 190. Visible on the second outwardly facing side 130 is button 200 accessible through the second outwardly facing side 130. In one embodiment the button 200 is part of a safety mechanism restricting access to the contents of the pill dispenser 100. Also visible in both the left and right sides of FIG. 1, is an outermost circumferential edge of a carousel 210. As will be fully described below, rotation of the carousel 210 delivers one pill at a time from an interior of the housing 110 to the opening 150. In one embodiment, the button 200 is configured to prevent rotation of the carousel 210 unless the button is depressed. The internal structure and function of button 200 are more fully described below. In one embodiment, a sliding door 220 (see FIG. 2) covers and uncovers the opening 150.

Referring to FIG. 2, the pill dispenser 100 is shown in an exploded view illustrating internal structure. The sliding door 220 is visible at the left side near a slot 230 in disposed in the first circumferential edge 140. In an open position the sliding door 220 is accommodated by the slot so that the opening 150 is uncovered. In a closed position the sliding door 220 covers the opening 150. A tab 250 on the sliding door 220 allows a user to move the sliding door 220 between open and closed positions. The housing 110 comprises a top cover 240, a bottom cover 250, and an internal member 260. The top cover 240 has an interior surface 270 that is generally flat.

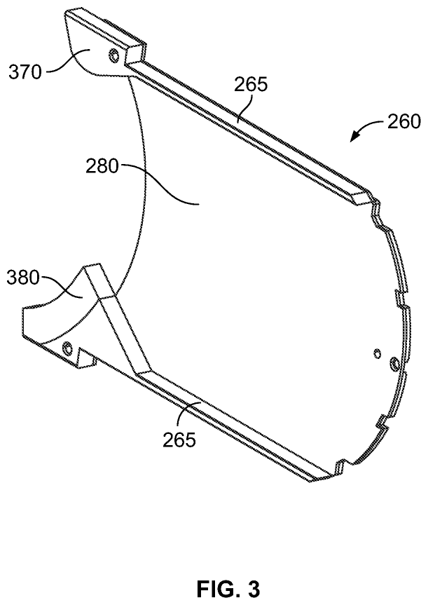

Referring now to FIG. 3, a top side 280 of the internal member 260 also has a generally flat surface. The interior surface 270 of the top cover 240 and the top side 280 of the internal member 260 oppose one another when assembled to define a space 290 therebetween (see FIGS. 2 and 4). In addition to defining the space 290, the internal member 260 provides a supporting guide for motion of a sliding member 310 (see FIGS. 2 and 4) toward the carousel 210. For example, in one embodiment, the internal member 260 includes rails 265 that further define lateral boundaries of the space 290 and that also serve as a supporting guide for the sliding member 310.

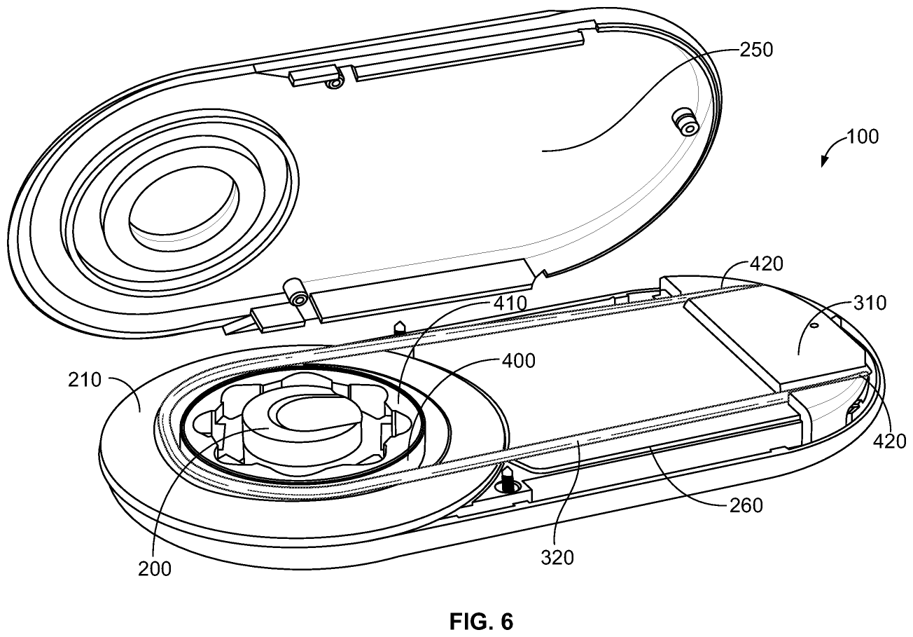

Referring to FIG. 4, the pill dispenser 100 is shown with the top cover 240 removed and the sliding door 220 disposed outside of the slot 230. The internal member 260 is visible though mostly covered by pills 300 disposed on top of the internal member 260 and within the space 290. The sliding member 310 (also shown separated from the internal member 260 in FIG. 2) is shown positioned at one end of the internal member 260 and defining a lateral edge of the space 290. The carousel 210 is shown disposed at the opposite end of the internal member 260 from the sliding member 310. The sliding member 310 is biased, for example, by an elastic band 320 (shown in FIGS. 2 and 6) to move toward the carousel on the internal member 260 through the space 290, for example, guided on the rails 265 or the like, toward the carousel 210.

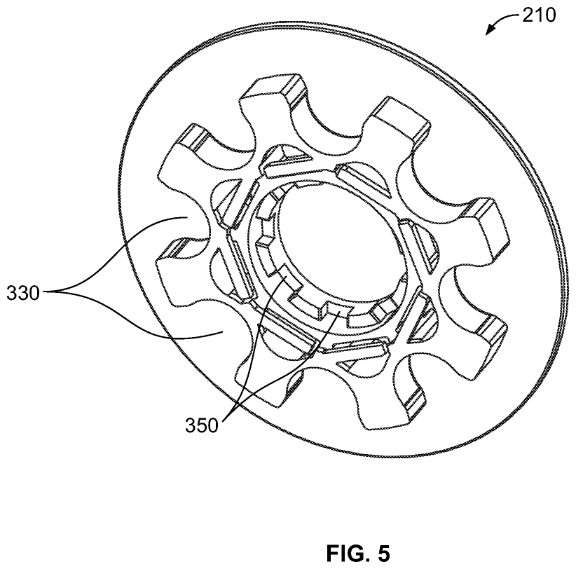

Referring to FIGS. 4 and 5, the carousel 210 is disposed around the button 200 and includes a plurality of outwardly facing recesses 330 disposed around the carousel 210. As can be seen in FIG. 4, each of the recesses 330 is sized to accommodate a single pill 300. The sliding member 310 pushes pills 300 disposed in the space 290 toward the carousel 210 and into the recesses 330 that are accessible from the space 290, one pill 300 per recess 330. The outermost circumferential edge of the carousel 210 extends past the first and second circumferential edges 140, 190 (see also FIG. 1) allowing a user to rotate the carousel 210. As the carousel 210 is rotated, each of the outwardly facing recesses 330 carrying a pill 300 rotates around so that the recess 330 and the pill 300 therein lines up with the opening 150 so that one pill 300 at a time can be dispensed through the opening 150. The sliding door 220 in the closed position can not only prevent prematurely delivered pills 300 from inadvertently being dispensed through the opening 150, but can also, for example, prevent external debris from entering the recesses 330 and ultimately from entering the space 190 as the recesses 330 rotate back around to the space 290.

As part of a safety mechanism to prevent undesirable access to the contents of the pill dispenser 100, for example, by children, in one embodiment rotation of the carousel 210 is only possible when the button 200 disposed through the carousel 210 is depressed. The safety mechanism locks the carousel 210 against rotation. In an undepressed position one or more radially extending protrusions 340 on the button 200 are accommodated within slots 350 (see FIGS. 4 and 5) disposed on the carousel 210, thereby interfering with rotation of the carousel 210. The button 200 is biased to remain in the undepressed position by, for example, a spring 360 (shown in FIGS. 2 and 4). When a user depresses the button 200 against the bias of the spring 360, the protrusions 340 are pushed free from interference with the slots 350 allowing the carousel 210 to rotate. In this depressed position the protrusions 340 enter into cover slots 370 that prevent the button 200 from inadvertently rotating with the carousel 210. Upon release of user force on the button 200, the spring 360 biases the button 200 back to the undepressed position, again locking the carousel 210 against rotation.

In another embodiment, the safety mechanism includes two opposing buttons (not shown) both buttons disposed through the carousel 210 and biased outwardly to remain in an undepressed position. In this embodiment, the first and second buttons are configured to prevent rotation of the carousel unless both of the first and second buttons are depressed. The first button is accessible through a first exterior surface of the housing 110, for example, the first outwardly facing side 120, and the second button is accessible through a second exterior surface of the housing 110, for example, the second outwardly facing side 130. The two buttons could, for example, be nested inside one another such that protrusions 340 on the buttons interfere with both sides of the carousel 210 to prevent rotation when the buttons are in an undepressed position. However, when both buttons are depressed against one another, the protrusions come free from interference with the carousel 210 allowing it to rotate.

Referring to FIGS. 3 and 4, the internal member 260 includes features that inhibit damage to the pills 300 as they are pushed into the recesses 330. Because of the geometry of the carousel 210 it is conceivable that one or more pills could get jammed between the carousel 210 and surfaces of the internal member 260. Once so jammed, any rotation of the carousel 210 could damage or destroy the pill 300. To address this possibility the internal member 260 includes first and second ramped walls 370, 380 that direct the pills 300 toward the recesses 330. The ramped walls 370, 380 also occupy parts of the space 290 that the pills 300 could otherwise occupy and end up being damaged. An arrow 390 visible on the carousel 210 in FIG. 3 shows the preferred direction of rotation of the carousel 210 consistent with the shapes of the ramped walls 370, 380 in this embodiment. Other embodiments may have a different direction of rotation of the carousel 210 and/or differently shaped ramps as may be necessary for the shapes of pills being dispensed.

Referring to FIG. 4, the position marker 180 is disposed on the sliding member 310. When the top cover 240 is affixed to the rest of the housing 110, for example, by screws, rivets, or other fasteners or methods of attachment as known in the art, the window 160 is disposed over the position marker 180 making the position marker 180 visible through the window 160. As shown in FIG. 3 when the space 190 is full of pills 300 and the sliding member 310 is disposed at an end of the internal member 260 furthest from the carousel 210, the position marker 180 is visible through the window 160 and is disposed near the top end of the scale 170 (shown in FIG. 1). As each successive pill 300 is dispensed the sliding member 310 repositions closer to the carousel 210 and the position marker 180 repositions under the window 160 and between the bottom and top ends of the scale 170. In this embodiment, the scale 170 (see FIG. 1) has a range of 0 to 40 corresponding to a pill dispenser 100 with a capacity of 40 pills, but in other embodiments the scale 170 could have other numerical values corresponding to the capacity of the particular pill dispenser.

Now referring to FIG. 6, the pill dispenser 100 is shown with the bottom cover 250 removed. The elastic band 320, for example, a rubber band, is disposed to bias the sliding member 310 toward the carousel 210. In one embodiment, the elastic band 320 is supported on a rigid ring 400, for example a metal ring. The rigid ring 400 is disposed around a hub portion 410 of the carousel 210 and allows the carousel 210 to rotate without transferring any rotational force to the rigid ring 400 or the elastic band 320. In one embodiment, the elastic band 320 is disposed around a first portion of the sliding member 310 positioned furthest from the carousel 210 and is accommodated within grooves 420 disposed through a second portion of the sliding member 310 disposed between the first portion and the carousel 210.

### INDUSTRIAL APPLICABILITY

The pill dispenser delivers a single pill at a time via manual rotation of a carousel that carries the pills from an interior of the dispenser to a dispensing opening. The carousel cannot be rotated unless a safety button is simultaneously depressed. A sliding door covers the dispensing opening in a closed position to keep debris out of the dispenser and uncovers the opening to allow pills to be dispensed.

Numerous modifications to the present invention will be apparent to those skilled in the art in view of the foregoing description. It is not desired to limit the invention to the exact construction and operation shown and described, and accordingly, all suitable modifications and equivalents may be resorted to, falling within the scope of the invention. Accordingly, this description is to be construed as illustrative only of the principles of the invention and is presented for the purpose of enabling those skilled in the art to make and use the invention and to teach the best mode of carrying out same. The exclusive rights to all modifications which come within the scope of the appended claims are reserved. All patents, patent publications and applications, and other references cited herein are incorporated by reference herein in their entirety.

1. A pill dispenser, comprising:
a housing having first and second opposing interior generally flat surfaces and an exterior circumferential edge;
a circular carousel disposed to rotate within the housing; where the carousel extends beyond the edge; and
outwardly facing recesses disposed on the carousel aligned with an opening disposed through the exterior circumferential edge.

2. The pill dispenser of claim 1, further comprising:
a button disposed through the carousel and accessible through an exterior surface of the housing, the button comprising a protrusion extending therefrom;
wherein:
when the button is in an undepressed position the protrusion interferes with rotation of the carousel; and
when the button is in a depressed position the protrusion is free from interfering with the carousel, allowing the carousel to rotate.

3. The pill dispenser of claim 2, wherein the button is biased to remain in the undepressed position.

4. The pill dispenser of claim 1, wherein a sliding member disposed in a space between the first and second surfaces is biased toward the carousel and pushes pills disposed in the space into the outwardly facing recesses.

5. The pill dispenser of claim 4, wherein the sliding member is biased by an elastic band.

6. The pill dispenser of claim 1, wherein the opening is covered when a sliding door is disposed in a closed position and the opening is uncovered when the sliding door is disposed in an open position.

7. The pill dispenser of claim 1, further comprising a window disposed over a second opening disposed through the housing allowing visual access to a marker disposed on the sliding member, wherein the position of the marker relative to a scale disposed along the window provides an indication of the number of pills disposed within the pill dispenser.

8. The pill dispenser of claim 4, wherein the second interior flat surface is defined by an internal member that provides a guide path for motion of the sliding member toward the carousel.

9. The pill dispenser of claim 8, wherein the internal member comprises ramped walls that direct pills toward the recesses.

10. A pill dispenser, comprising:
a housing having first and second opposing interior generally flat surfaces and an exterior circumferential edge; and
a circular carousel disposed to rotate within the housing,
the circular carousel extending beyond the exterior circumferential edge,
outwardly facing recesses disposed on the carousel aligned with an opening disposed through the edge, and
at least one button accessible through an exterior surface of the housing and configured to prevent rotation of the carousel unless the at least one button is depressed.

11. The pill dispenser of claim 10, wherein the at least one button comprises:
a first button disposed through the carousel and accessible through a first exterior surface of the housing; and
a second button disposed through the carousel and accessible through a second exterior surface of the housing,
wherein:
when the first and second buttons are both in an undepressed position, protrusions on the buttons interfere with rotation of the carousel; and
when the first and second buttons are both in a depressed position the protrusions are free from interfering with the carousel, allowing the carousel to rotate.

12. The pill dispenser of claim 11, wherein both the first and second buttons are biased to remain in the undepressed position.

13. The pill dispenser of claim 10, wherein a sliding member disposed in a space between the first and second surfaces is biased toward the carousel, and the sliding member pushes pills disposed in the space toward the carousel so that one pill is pushed into each of the recesses accessible from the space.

14. The pill dispenser of claim 13, wherein the one pill is dispensed through the opening by rotating the carousel until the opening lines up with the one pill.

15. The pill dispenser of claim 10, wherein the opening is covered when a sliding door is disposed in a closed position and the opening is uncovered when the sliding door is disposed in an open position, and where a slot disposed in the edge accommodates the sliding door when it is disposed in the open position.

16. A pill dispenser, comprising:
a housing having first and second opposing interior generally flat surfaces defining a space therebetween for accommodating pills, and an exterior circumferential edge; and
a circular carousel disposed to rotate within the housing; where the carousel extends beyond the edge,
outwardly facing recesses disposed on the carousel being aligned with an opening disposed through the edge, and
at least one button being accessible through an exterior surface of the housing and configured to prevent rotation of the carousel unless the at least one button is depressed,
the pill dispenser configured such that rotation of the carousel when the at least one button is depressed delivers one pill per recess from the space to the opening.

17. The pill dispenser of claim 16, wherein the at least one button comprises first and second buttons both accessible through exterior surfaces of the housing, where the first and second buttons are configured to prevent rotation of the carousel unless both of the first and second buttons are depressed.

18. The pill dispenser of claim 17, wherein both the first and second buttons are biased to remain in an undepressed position.

19. The pill dispenser of claim 16, wherein a sliding member disposed in the space is biased toward the carousel and pushes pills disposed in the space toward the carousel.

20. The pill dispenser of claim 19, wherein the sliding member is biased by an elastic band and pushes one pill into each recess accessible from the space.
